(19) United States
(12) Patent Application Publication
(10) Pub. No.: US 2026/0020127 A1
(43) Pub. Date: Jan. 15, 2026

(54) LED LAMP

(71) Applicant: SHENZHEN SNC OPTO ELECTRONIC CO., LTD., Shenzhen (CN)

(72) Inventors: Jianjun Xu, Shenzhen (CN); Xingrao Wu, Shenzhen (CN)

(21) Appl. No.: 18/945,651

(22) Filed: Nov. 13, 2024

(30) Foreign Application Priority Data
Jul. 9, 2024 (CN) 202410911752.7

(51) Int. Cl. H05B 47/155; F21V 21/06; F21V 23/04; F21V 23/06; F21V 29/70; F21V 31/00; F21Y 115/10; H05B 45/10; H05B 45/20

(52) U.S. Cl. CPC H05B 47/155; F21V 21/06; F21V 23/0464; F21V 23/06; F21V 29/70; F21V 31/005; H05B 45/10; H05B 45/20; F21Y 2115/10

(57) ABSTRACT

An LED lamp includes a heat dissipation base provided with a first mounting groove and a second mounting groove; an LED lamp panel received in the first mounting groove and including a plurality of light-emitting elements; a lens plate covering the LED lamp panel; a driving power supply electrically connected to the LED lamp panel and configured to supply power to the plurality of light-emitting elements; and an angle controller fixed in the second mounting groove, the angle controller being electrically connected to the LED lamp panel and the driving power supply and configured to control the light-emitting elements corresponding to different areas of the lens plate to emit light.

### CROSS-REFERENCE TO RELATED APPLICATION

The present application claims priority of Chinese Patent Application No. 202410911752.7, filed with the Chinese Patent Office on Jul. 9, 2024, and entitled “LED LAMP”, the entire content of which is incorporated herein in its entity

### TECHNICAL FIELD

The present disclosure relates to the field of lighting devices, and in particular relates to an LED lamp.

### BACKGROUND

LED lamps have many advantages such as energy-saving, environmental protection, long life and so on, and have been widely used in various lighting places. The conventional LED lamp generally includes a lens plate. However, the position of the lens plate of the existing LED lamp is fixed and cannot be flexibly adjusted according to the requirements of different places of use, so that a light distribution direction of the LED lamp cannot be adjusted.

### SUMMARY

Accordingly, an LED lamp is provided.

An LED lamp includes a heat dissipation base provided with a first mounting groove and a second mounting groove; an LED lamp panel received in the first mounting groove and including a plurality of light-emitting elements; a lens plate covering the LED lamp panel; a driving power supply electrically connected to the LED lamp panel and configured to supply power to the plurality of light-emitting elements; and an angle controller fixed in the second mounting groove, the angle controller being electrically connected to the LED lamp panel and the driving power supply and configured to control the light-emitting elements corresponding to different areas of the lens plate to emit light.

In one of the embodiments, the LED lamp further includes a frame pressing assembly covering the angle controller, the frame pressing assembly includes a cover plate, a first sealing ring, and an end cover, the cover plate covers the angle controller, the first sealing ring is received in the second mounting groove and sealingly surrounds the angle controller, and the end cover covers the cover plate and is fixed to the heat dissipation base.

In one of the embodiments, the angle controller includes a first switch base, a first control switch, a second control switch, a third control switch, and a fourth control switch, the first switch base is fixed in the second mounting groove, the first control switch, the second control switch, the third control switch, and the fourth control switch are fixed on the first switch base, the first control switch includes a first electronic switch and a first toggle connected to the first electronic switch, the second control switch includes a second electronic switch and a second toggle connected to the second electronic switch, the third control switch includes a third electronic switch and a third toggle connected to the third electronic switch, the fourth control switch includes a fourth electronic switch and a fourth toggle connected to the fourth electronic switch, the first electronic switch, the second electronic switch, the third electronic switch, and the fourth electronic switch are electrically connected to the driving power supply and the LED lamp panel, the LED lamp panel includes a first area, a second area, a third area, and a fourth area, the first toggle, the second toggle, the third toggle, and the fourth toggle are configured to be toggled to change states of the first electronic switch, the second electronic switch, the third electronic switch, and the fourth electronic switch, respectively, and the first electronic switch, the second electronic switch, the third electronic switch, and the fourth electronic switch are respectively configured to control the light-emitting elements corresponding to the first area, the second area, the third area, and the fourth area on the LED lamp panel emit to light according to different states thereof.

In one of the embodiments, the LED lamp further includes a light-controlled switch fixed in the first mounting groove, the light-controlled switch includes a second switch base, a light-controlled sensor, a fifth electronic switch, and a fifth toggle, the fifth electronic switch is electrically connected to the driving power supply and the light-controlled sensor, the fifth toggle is configured to be toggled to change a state of the fifth electronic switch, the fifth electronic switch is configured to switch on the light-controlled sensor according to different states thereof, and the light-controlled sensor is configured to sense a brightness of an external environment and switch on the light-emitting elements in response to the brightness of the external environment being lower than a preset value.

In one of the embodiments, the LED lamp further includes a power supply box and a connecting member, the driving power supply is fixed in the power supply box, the connecting member is provided on a side of the lens plate away from the LED lamp panel, the LED lamp panel and the lens plate are respectively provided with a first through hole and a second through hole, one end of the connecting member extends through the second through hole and is engaged in the first through hole, another end of the connecting member is movably connected to the power supply box, and the LED lamp further includes a second sealing ring provided between the connecting member and the power supply box.

In one of the embodiments, an inner side of an end of the connecting member connected to the power supply box is provided with a plurality of inner clamping blocks spaced apart, the power supply box is provided with a plurality of outer clamping blocks spaced apart, and each inner clamping block is movably provided between adjacent two outer clamping blocks.

In one of the embodiments, the LED lamp further includes a color temperature controller provided in the power supply box, the color temperature controller includes a third switch base, a sixth electronic switch, and a sixth toggle, the sixth electronic switch is electrically connected to the driving power supply and the LED lamp panel, the sixth toggle is configured to be toggled to change a state of the sixth electronic switch, and the sixth electronic switch is configured to adjust a color temperature of the LED lamp according to different states thereof.

In one of the embodiments, the LED lamp further includes a lampshade sleeved on the connecting member and a housing fixed on an outer side of the lampshade.

In one of the embodiments, the LED lamp further includes a lamp post, the lamp post includes a lamp post base and a bracket fixed to the lamp post base, and the bracket is provided with electrical terminals configured to be electrically connected to the driving power supply.

In one of the embodiments, the LED lamp further includes a socket fixed in the lamp post and electrically connected to the electrical terminals, the socket is provided with an opening and an accommodating groove in communication with the opening, the socket includes a bottom plate received in the accommodating groove, the socket further includes a power strip, a USB interface charger, and a network cable interface that are fixed on the bottom plate, the lamp post further includes a door locking assembly, the door locking assembly includes a door plate provided in the opening, the door plate is provided with a locking column, the socket is provided with an inserting hole, the locking column is rotatably inserted in the inserting hole, so that the door plate is rotatably connected to the socket to open and close the opening, a damping spring is sleeved on the locking column, and the door locking assembly further includes a third sealing ring provided between the socket and the door plate.

### BRIEF DESCRIPTION OF THE DRAWINGS

The drawings are for illustrative purposes only and are only schematic drawings, not physical drawings, and shall not be construed as limiting this patent. In order to better explain the embodiment of the utility model, some parts of the drawings may be omitted, enlarged or reduced, which does not represent the size of the actual product. It will be appreciated by those skilled in the art that some of the known structures and their descriptions in the drawings may be omitted.

FIG. 1 is a perspective view of an LED lamp according to an embodiment of the present disclosure.

FIG. 2 is an exploded view of the LED lamp of FIG. 1.

FIG. 3 is an enlarged view of a portion A of FIG. 2.

FIG. 4 is a schematic view of an LED lamp panel according to an embodiment.

FIG. 5 is a sectional view of the LED lamp of FIG. 1.

FIG. 6 is a partial enlarged view of FIG. 5

FIG. 7 is a perspective view of a light-controlled switch according to an embodiment.

FIG. 8 is a perspective view of a color temperature controller according to an embodiment.

FIG. 9 is a perspective view of a connecting member according to an embodiment.

FIG. 10 is a perspective view of a power supply box according to an embodiment.

FIG. 11 is another exploded view of the LED lamp of FIG. 1 according to a first embodiment.

FIG. 12 is another exploded view of the LED lamp of FIG. 1 according to a second embodiment.

FIG. 13 is an enlarged view of a portion B of FIG. 12.

### DESCRIPTION OF REFERENCE SIGNS

1. Heat dissipation base; 2. LED lamp panel; 3. Lens plate; 4. Driving power supply; 5. First mounting groove 1; 6. Second mounting groove; 7. Light-emitting element; 8. Angle controller; 9. First area; 10. Second area; 11. Third area; 12. Fourth area; 13. Cover plate; 14. First sealing ring; 15. End cover; 16. First switch base; 17. First control switch; 18. Second control switch; 19. Third control switch; 20. Fourth control switch; 21. First electronic switch; 22. First toggle; 23. Second electronic switch; 24. Second toggle; 25. Third electronic switch; 26. Third toggle; 27. Fourth electronic switch; 28. Fourth toggle; 29. Light-controlled switch; 30. Second switch base; 31. Fifth electronic switch; 32. Fifth toggle; 33. Power supply box; 34. Connecting member; 35. First through hole; 36. Second sealing ring; 37. Inner clamping block; 38. Outer clamping block; 39. Color temperature controller; 40. Third switch base; 41. Sixth electronic switch; 42. Sixth toggle; 43. Lampshade; 44. Housing; 45. Lamp post; 46. Lamp post base; 47. Bracket; 48. Socket; 49. Accommodating groove; 50. Bottom plate; 51. Power strip; 52. USB interface charger; 53. Network cable interface; 54. Door plate; 55. Latch; 56. Locking column; 57. Damping spring; 58. Third sealing ring; 59. Blocking member; 60. Threaded hole; 61. Aluminum cover; 70. Light-controlled sensor; 71. Hollow column; 72. Receiving groove; 80. Second through hole; 90. Opening.

### DETAILED DESCRIPTION OF THE EMBODIMENTS

The technical solution in the embodiment of the present disclosure will be clearly and completely described below in conjunction with the drawings in the embodiment of the application. Apparently, the described embodiments are only some of the embodiments of the application, not all of them. Based on the embodiments in the present disclosure, all other embodiments obtained by a person skilled in the art without making creative efforts shall all fall within the protection scope of the present disclosure.

In the drawings of the embodiments of the present disclosure, the same or similar numbers correspond to the same or similar components. In the description of the present disclosure, it should be understood that terms “upper”, “lower”, “front” and “rear”, “left”, “right”, “vertical”, “horizontal”, “lateral”, “longitudinal”, “top”, “bottom”, “inner”, “outer”, and other indicated orientation or positional relationships are based on the orientation or positional relationship shown in the drawings for convenience and simplicity of description of the present disclosure only, and not as an indication or implication that the devices or elements referred to must have or be constructed or operated in a specific orientation. Therefore, the terms describing positional relationships in the drawings are only for illustrative purposes and should not be construed as limitations of the present disclosure.

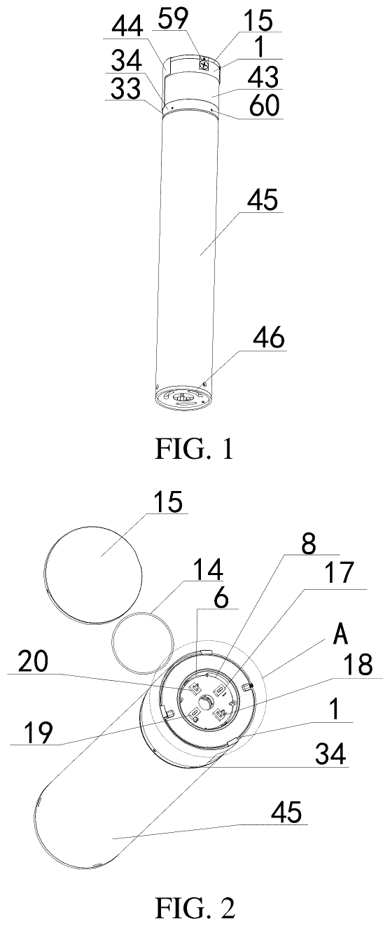

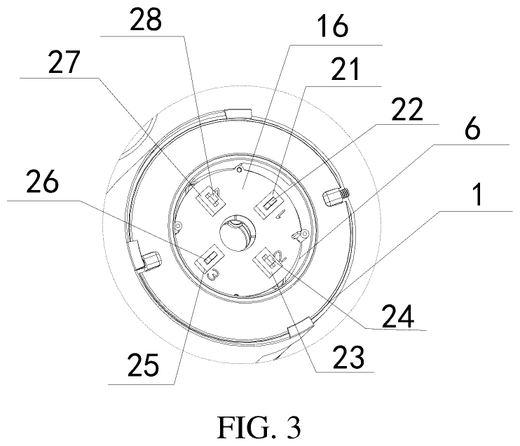

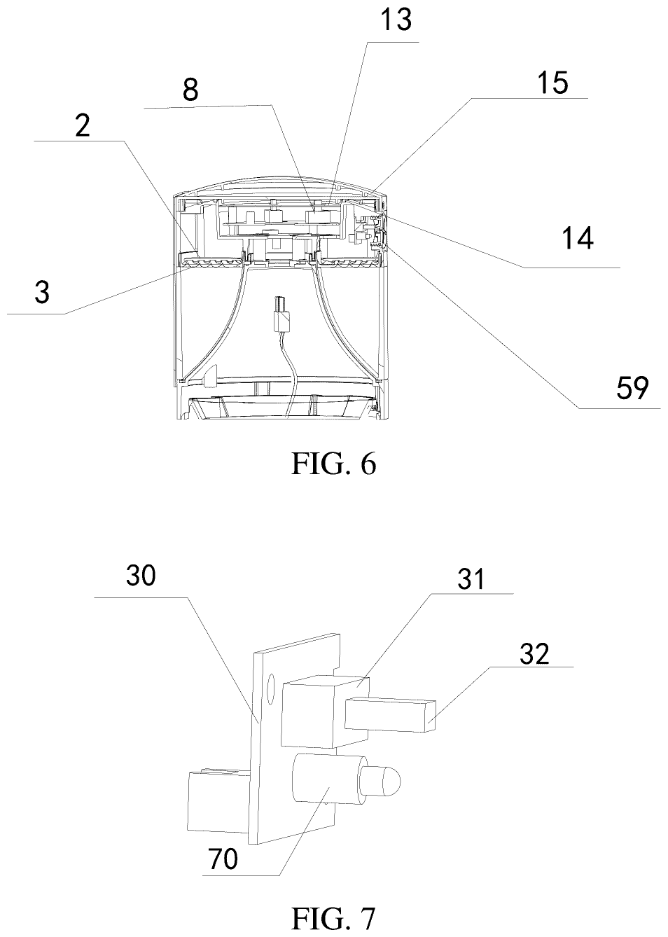

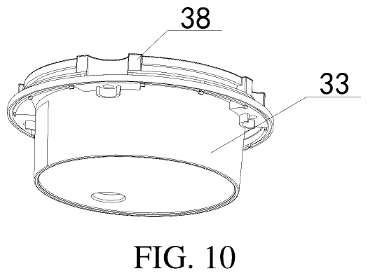

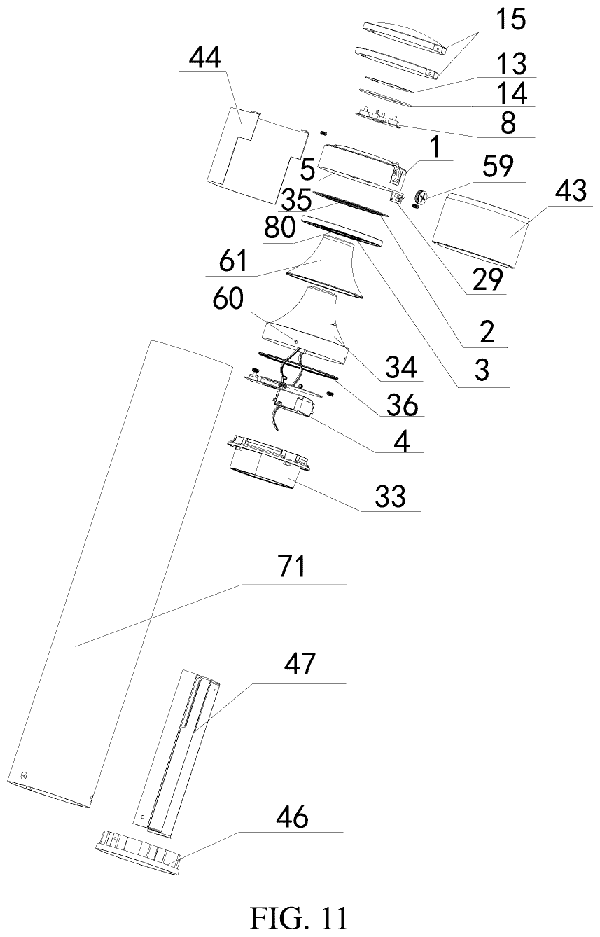

Referring to an embodiment of the present disclosure shown in FIGS. 1 to 11, an LED lamp includes a heat dissipation base 1, an LED lamp panel 2, a lens plate 3, and a driving power supply 4. The driving power supply 4 is electrically connected to the LED lamp panel 2 and configured to supply power to the LED lamp panel 2. The dissipation base 1 is provided with a first mounting groove 5 and a second mounting groove 6. The LED lamp panel 2 is received in the first mounting groove 5 and includes a plurality of light-emitting elements 7. The lens plate 3 covers the LED lamp panel 2. The LED lamp further includes an angle controller 8 fixed in the second mounting groove 6. The angle controller 8 is electrically connected to the LED lamp panel 2 and the driving power supply 4 and configured to control the light-emitting elements 7 corresponding to different areas on the lens plate 3 to emit light.

By providing the angle controller 8, when a light angle of the LED lamp needs to be adjusted, only the angle controller 8 needs to be adjusted to control the light-emitting elements 6 corresponding to different areas on the lens plate 3 to emit light.

The LED lamp further includes a frame pressing assembly covering the angle controller 8. The frame pressing assembly includes a cover plate 13, a first sealing ring 14, and an end cover 15. The cover plate 13 covers the angle controller 8. The first sealing ring 14 is received in the second mounting groove 6 and sealingly surrounds the angle controller 8, so that the angle controller 8 can achieve a good waterproof effect. The end cover 15 covers the cover plate 13 and is fixed to the heat dissipation base 1. One or two end covers 15 may be provided.

Referring to FIGS. 1 and 2, the angle controller 8 includes a first switch base 16, a first control switch 17, a second control switch 18, a third control switch 19, and a fourth control switch 20. The first switch base 16 is fixed in the second mounting groove 6. The first control switch 17, the second control switch 18, the third control switch 19, and the fourth control switch 20 are fixed on the first switch base 16. The first control switch 17 includes a first electronic switch 21 and a first toggle 22 connected to the first electronic switch 21. The second control switch 18 includes a second electronic switch 23 and a second toggle 24 connected to the second electronic switch 23. The third control switch 19 includes a third electronic switch 25 and a third toggle 26 connected to the third electronic switch 25. The fourth control switch 20 includes a fourth electronic switch 27 and a fourth toggle 28 connected to the fourth electronic switch 27. The first electronic switch 21, the second electronic switch 23, the third electronic switch 25, and the fourth electronic switch 27 are electrically connected to the driving power supply 4 and the LED lamp panel 2.

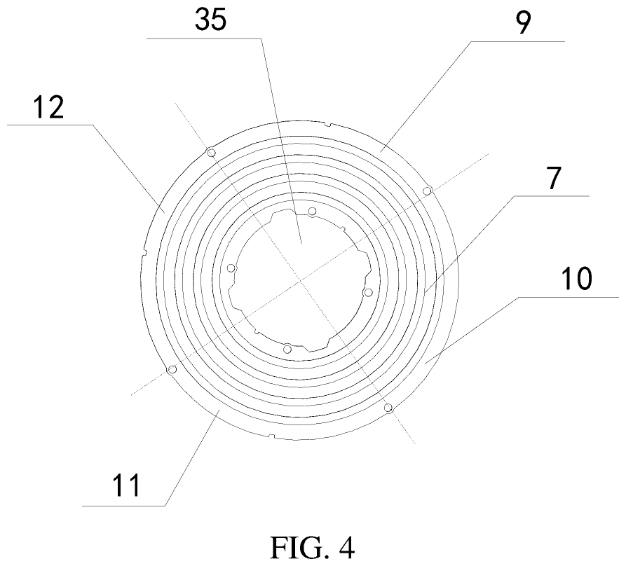

Referring to FIG. 4, the first control switch 17, the second control switch 18, the third control switch 19, and the fourth control switch 20 respectively control the light-emitting elements 7 corresponding to four areas on the LED lamp panel 2 to emit light. Specifically, the LED lamp panel 2 includes four areas, namely a first area 9, a second area 10, a third area 11, and a fourth area 12. The first toggle 22, the second toggle 24, the third toggle 26, and the fourth toggle 28 are configured to be toggled to change states of the first electronic switch 21, the second electronic switch 23, the third electronic switch 25, and the fourth electronic switch 27, respectively. The first electronic switch 21, the second electronic switch 23, the third electronic switch 25, and the fourth electronic switch 27 are respectively configured to control the light-emitting elements 7 corresponding to the first area 9, the second area 10, the third area 11, and the fourth area 12 on the LED lamp panel 2 to emit light according to different states thereof. When the light-emitting elements 7 on the first area 9 are required to emit light, only the first toggle 22 needs to be toggled. When the light-emitting elements 7 on the second area 10 are required to emit light, only the second toggle 24 needs to be toggled. When the light-emitting elements 7 on the third area 11 are required to emit light, only the third toggle 26 needs to be toggled; When the light-emitting elements 7 on the fourth area 12 are required to emit light, only the fourth toggle 28 needs to be toggled.

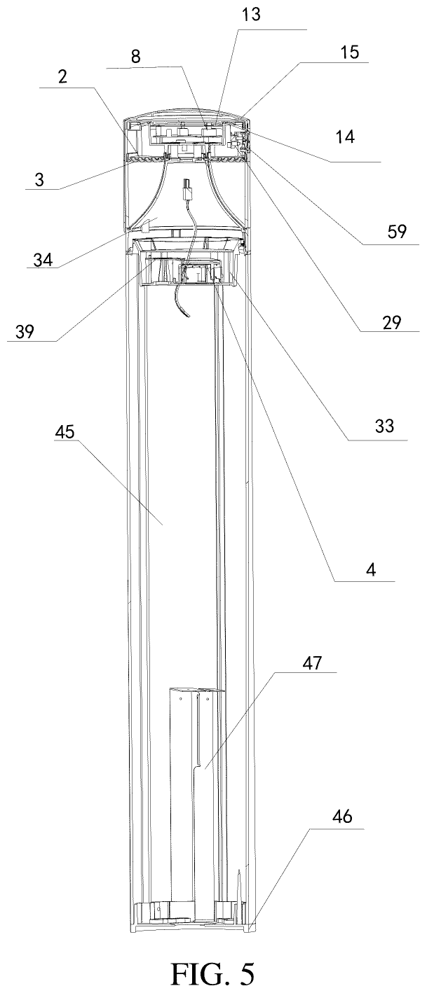

Referring to FIGS. 5 to 7, the LED lamp further includes a light-controlled switch 29 fixed in the first mounting groove 5. The light-controlled switch 29 includes a second switch base 30, a light-controlled sensor 70, a fifth electronic switch 31, and a fifth toggle 32. The fifth electronic switch 31 is electrically connected to the driving power supply 4 and the light-controlled sensor 70. The fifth toggle 32 is configured to be toggled to change a state of the fifth electronic switch 31, and the fifth electronic switch 31 is configured to switch on the light-controlled sensor 70 according to different states thereof. When the light control sensor needs to be switched on, the fifth toggle 32 is toggled to switch on or switch off the light control sensor. The light-controlled sensor 70 is configured to sense a brightness of an external environment and turn on the light-emitting elements 7 in response to the brightness of the external environment being lower than a preset value.

The LED lamp further includes a blocking member 59 detachably connected to the heat dissipation base 1. The blocking member 59 is configured to cover the fifth toggle 32. When the light-controlled sensor 70 needs to be switched on, the blocking member 59 is detached from the heat dissipation base 1 to expose the fifth toggle 32 and the fifth toggle 32 is toggled to switch on the light-controlled sensor 70.

Referring to FIGS. 9 to 12, the LED lamp further includes a power supply box 33 and a connecting member 34 having a hollow structure. The driving power supply 4 is fixed in the power supply box 33. The connecting member 34 is provided on a side of the lens plate 3 away from the LED lamp panel 2. The LED lamp panel 2 and the lens plate 3 are respectively provided with a first through hole 35 and a second through hole 80. One end of the connecting member 34 extends through the second through hole 80 and is engaged in the first through hole 35, and the other end of the connecting member 34 is movably connected to the power supply box 33. The LED lamp further includes a second sealing ring 36 provided between the connecting member 34 and the power supply box 33, so that the power box 33 can achieve a good waterproof effect. In order to better dissipate heat of the LED lamp board 2, the LED lamp may further include an aluminum cover 61 sleeved on the connecting member 34.

An inner side of an end of the connecting member 34 connected to the power supply box 33 is provided with a plurality of inner clamping blocks 37 spaced apart. Correspondingly, the power supply box 33 is provided with a plurality of outer clamping blocks 38 spaced apart. Each inner clamping block 37 is movably provided between adjacent two outer clamping blocks 38. The connecting member 34 is provided with a threaded hole 60. When the connecting member 34 is locked, a screw extends through the threaded hole 60 and abuts against the power supply box 33. When the angle needs to be adjusted, the screw is unscrewed, and then the connecting member 34 is rotated clockwise or counterclockwise, so that each inner clamping block 37 moves between corresponding adjacent two outer clamping blocks 37 until the angle is adjusted to the required angle. Then the connecting member 34 is fixed to the power supply box 33 through the screw. Each inner clamping block 37 can move between adjacent two outer blocks 38 at an angle of 0° to 55°.

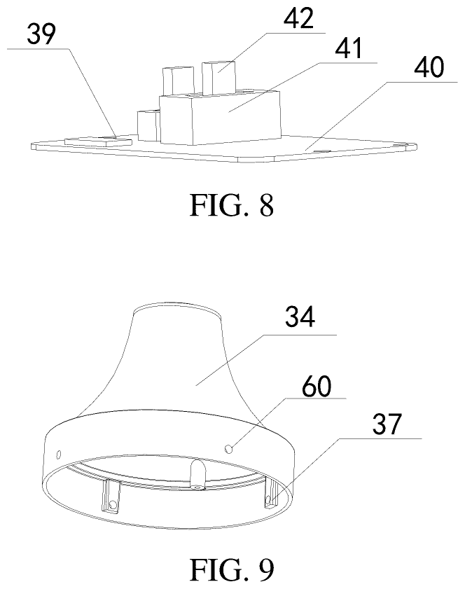

Referring to FIG. 8, the LED lamp further includes a color temperature controller 39 provided in the power supply box 33. The color temperature controller 39 includes a third switch base 40, a sixth electronic switch 41, and a sixth toggle 42. The sixth electronic switch 41 is electrically connected to the driving power supply 4 and the LED lamp panel 2. The sixth toggle 42 is configured to be toggled to change a state of the sixth electronic switch 41, and the sixth electronic switch 41 is configured to adjust a color temperature of the LED lamp according to different states thereof. When the color temperature of the LED lamp needs to be adjusted, only the sixth toggle 42 needs to be toggled.

The LED lamp may further include a lampshade 43, and the lampshade 43 is sleeved on the connecting member 34. In some embodiments, the LED lamp includes the lampshade 43 but no lens plate 3, and the light emitted by the light-emitting element 7 is guided to an external environment through the lampshade 43. The LED lamp may further include a housing 44 fixed on an outer side of the lampshade 43.

The LED lamp further includes a lamp post 45 connected to the power supply box. The lamp post 45 includes a lamp post base 46 and a bracket 47 fixed to the lamp post base 46. The bracket 47 is provided with electrical terminals configured to be electrically connected to the driving power supply 4.

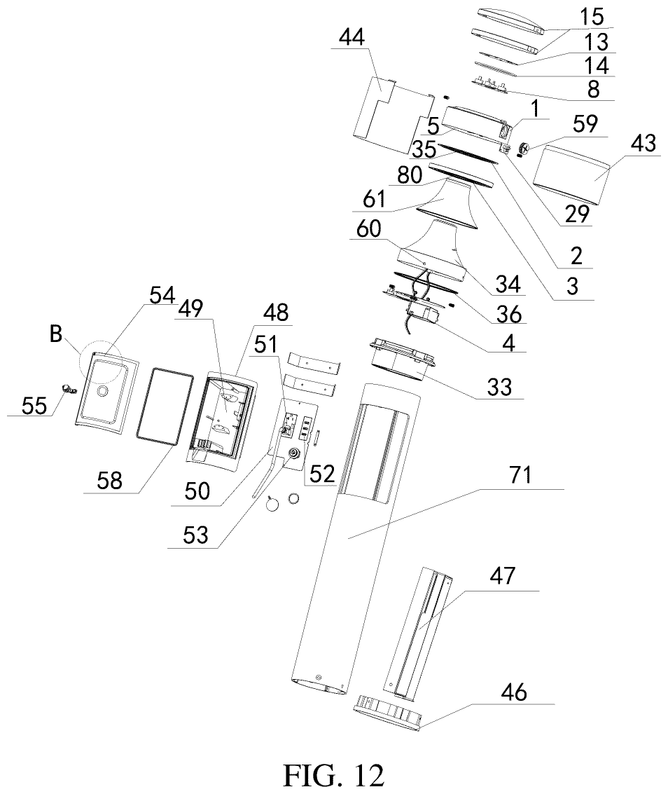

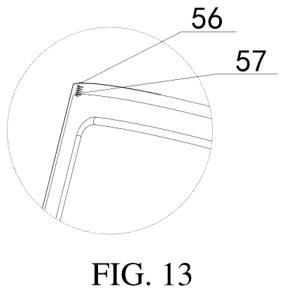

Referring to FIG. 12 and FIG. 13, an LED lamp is provided according to a second embodiment, the structure of the LED lamp in the second embodiment is substantially the same as the structure of the LED lamp in the first embodiment, and the difference lies mainly in that the LED lamp further includes a socket 48 fixed in the lamp post 45 and electrically connected to the electrical terminals. The socket 48 is provided with an opening 90 and an accommodating groove 49 in communication with the opening 90. The socket 48 includes a bottom plate 50 received in the accommodating groove 49. The socket 48 further includes a power strip 51, a USB interface charger 52, and a network cable interface 53 that are fixed on the bottom plate 50. The power strip 51 or the USB interface charger 52 can be used for charging an external device as required, and the network cable interface 53 can be connected to a network cable to access the internet.

The lamp post 45 further includes a hollow column 71 sleeved on the bracket 47 and a door locking assembly. A side surface of the hollow column 71 is provided with a receiving groove 72, and the socket 48 is fixed in the receiving groove 72. The door locking assembly includes a door plate 54 provided in the opening 90 and a latch 55. The door plate 54 is provided with a locking column 56. Correspondingly, the socket 48 is provided with an inserting hole. The locking column 56 is rotatably inserted in the inserting hole, so that the door plate 54 is rotatably connected to the socket 48 to open and close the opening 90. A damping spring 57 is sleeved on the locking column 56. By providing the damping spring 57, when a user opens the latch 55 with a key, the door plate 54 is automatically opened. The door locking assembly further includes a third sealing ring 58 provided between the socket 48 and the door plate 54, so that the socket 48 can achieve a good waterproof effect.

According to the above-mentioned LED lamp, the lens plate 3 does not need to be replaced, and a light angle of the LED lamp can be adjusted only by toggling the angle controller 8 to switch the light-emitting elements 7 of different areas to emit light. The cost for replacing the lens plate 3 is saved, and the operation is safer and more reliable. In addition, the LED lamp has the functions of charging a mobile phone and connecting to a network, so that the problem of accessing the internet and charging the mobile phone can be solved, and the mounting cost is saved.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure.

What is claimed is:

1. An LED lamp, comprising:
a heat dissipation base provided with a first mounting groove and a second mounting groove;
an LED lamp panel received in the first mounting groove and comprising a plurality of light-emitting elements;
a lens plate covering the LED lamp panel;
a driving power supply electrically connected to the LED lamp panel and configured to supply power to the plurality of light-emitting elements; and
an angle controller fixed in the second mounting groove, the angle controller being electrically connected to the LED lamp panel and the driving power supply and configured to control the light-emitting elements corresponding to different areas of the lens plate to emit light.

2. The LED lamp according to claim 1, further comprising a frame pressing assembly covering the angle controller, wherein the frame pressing assembly comprises a cover plate, a first sealing ring, and an end cover, the cover plate covers the angle controller, the first sealing ring is received in the second mounting groove and sealingly surrounds the angle controller, and the end cover covers the cover plate and is fixed to the heat dissipation base.

3. The LED lamp according to claim 1, wherein the angle controller comprises a first switch base, a first control switch, a second control switch, a third control switch, and a fourth control switch, the first switch base is fixed in the second mounting groove, the first control switch, the second control switch, the third control switch, and the fourth control switch are fixed on the first switch base, the first control switch comprises a first electronic switch and a first toggle connected to the first electronic switch, the second control switch comprises a second electronic switch and a second toggle connected to the second electronic switch, the third control switch comprises a third electronic switch and a third toggle connected to the third electronic switch, the fourth control switch comprises a fourth electronic switch and a fourth toggle connected to the fourth electronic switch, the first electronic switch, the second electronic switch, the third electronic switch, and the fourth electronic switch are electrically connected to the driving power supply and the LED lamp panel, the LED lamp panel comprises a first area, a second area, a third area, and a fourth area, the first toggle, the second toggle, the third toggle, and the fourth toggle are configured to be toggled to change states of the first electronic switch, the second electronic switch, the third electronic switch, and the fourth electronic switch, respectively, and the first electronic switch, the second electronic switch, the third electronic switch, and the fourth electronic switch are respectively configured to control the light-emitting elements corresponding to the first area, the second area, the third area, and the fourth area on the LED lamp panel emit to light according to different states thereof.

4. The LED lamp according to claim 3, further comprising a light-controlled switch fixed in the first mounting groove, wherein the light-controlled switch comprises a second switch base, a light-controlled sensor, a fifth electronic switch, and a fifth toggle, the fifth electronic switch is electrically connected to the driving power supply and the light-controlled sensor, the fifth toggle is configured to be toggled to change a state of the fifth electronic switch, the fifth electronic switch is configured to switch on the light-controlled sensor according to different states thereof, and the light-controlled sensor is configured to sense a brightness of an external environment and switch on the light-emitting elements in response to the brightness of the external environment being lower than a preset value.

5. The LED lamp according to claim 4, further comprising a power supply box and a connecting member, wherein the driving power supply is fixed in the power supply box, the connecting member is provided on a side of the lens plate away from the LED lamp panel, the LED lamp panel and the lens plate are respectively provided with a first through hole and a second through hole, one end of the connecting member extends through the second through hole and is engaged in the first through hole, another end of the connecting member is movably connected to the power supply box, and the LED lamp further comprises a second sealing ring provided between the connecting member and the power supply box.

6. The LED lamp according to claim 5, wherein an inner side of an end of the connecting member connected to the power supply box is provided with a plurality of inner clamping blocks spaced apart, the power supply box is provided with a plurality of outer clamping blocks spaced apart, and each inner clamping block is movably provided between adjacent two outer clamping blocks.

7. The LED lamp according to claim 6, further comprising a color temperature controller provided in the power supply box, wherein the color temperature controller comprises a third switch base, a sixth electronic switch, and a sixth toggle, the sixth electronic switch is electrically connected to the driving power supply and the LED lamp panel, the sixth toggle is configured to be toggled to change a state of the sixth electronic switch, and the sixth electronic switch is configured to adjust a color temperature of the LED lamp according to different states thereof.

8. The LED lamp according to claim 7, further comprising a lampshade sleeved on the connecting member and a housing fixed on an outer side of the lampshade.

9. The LED lamp according to claim 8, further comprising a lamp post, wherein the lamp post comprises a lamp post base and a bracket fixed to the lamp post base, and the bracket is provided with electrical terminals configured to be electrically connected to the driving power supply.

10. The LED lamp according to claim 9, further comprising a socket fixed in the lamp post and electrically connected to the electrical terminals, wherein the socket is provided with an opening and an accommodating groove in communication with the opening, the socket comprises a bottom plate received in the accommodating groove, the socket further comprises a power strip, a USB interface charger, and a network cable interface that are fixed on the bottom plate, the lamp post further comprises a door locking assembly, the door locking assembly comprises a door plate provided in the opening, the door plate is provided with a locking column, the socket is provided with an inserting hole, the locking column is rotatably inserted in the inserting hole, so that the door plate is rotatably connected to the socket to open and close the opening, a damping spring is sleeved on the locking column, and the door locking assembly further comprises a third sealing ring provided between the socket and the door plate.
